(19) United States
(12) Patent Application Publication
(10) Pub. No.: US 2026/0343120 A1
(43) Pub. Date: Oct. 29, 2026

(54) IMAGE SENSOR WITH TIME-OF-FLIGHT PIXEL CELL AND METHODS THEREOF

(71) Applicant: OMNIVISION TECHNOLOGIES, INC., Santa Clara, CA (US)

(72) Inventors: Sohei Manabe, San Jose, CA (US); Nagataka Tanaka, Yokohama (JP); Keiji Mabuchi, Cupertino, CA (US)

(21) Appl. No.: 19/193,350

(22) Filed: Apr. 29, 2025

(51) Int. Cl. H04N 25/766; H04N 25/705; H04N 25/77

(52) U.S. Cl. CPC H04N 25/766; H04N 25/705; H04N 25/77

(57) ABSTRACT

An image sensor comprising a plurality of pixels arranged in rows and columns to form a pixel array, a plurality of spectral filters to configure the plurality of pixels as visible pixels or non-visible pixels, a plurality of imaging control lines, and a plurality of time-of-flight control lines is described. Each pixel included in the plurality of pixels corresponds to a repeat unit including a photodiode to accumulate charge in response to incident light, a floating diffusion configured to receive the charge, and a transfer gate configured to selectively transfer the charge from the photodiode to the floating diffusion. The plurality of imaging control lines is coupled to the transfer gate of the visible pixels to configure the visible pixels as imaging pixels. The plurality of time-of-flight control lines are coupled to the transfer gate of the non-visible pixels to configure the non-visible pixels as time-of-flight pixel cells.

### TECHNICAL FIELD

This disclosure relates generally to image sensors, and in particular but not exclusively, relates to CMOS image sensors and applications thereof.

### BACKGROUND INFORMATION

Interest in three-dimensional (3D) cameras is increasing as the popularity of 3D applications continues to grow in areas such as imaging, movies, games, computers, user interfaces, facial recognition, object recognition, augmented reality, depth or distance detection or measurement, and the like. A typical passive way to create 3D images is to use multiple cameras to capture stereo or multiple images. Using the stereo images, objects in the images can be triangulated to create the 3D image or otherwise determine a distance between the image sensor and the object. One disadvantage with the triangulation technique is that it is difficult to create 3D images using small devices because there must be a minimum separation distance between each camera in order to create the 3D images. In addition, this technique is complex and therefore requires significant computer processing power in order to create the 3D images in real time.

For applications that require the acquisition of 3D images in real time, active depth imaging systems based on time-of-flight measurements are sometimes utilized. Time-of-flight cameras typically employ a light source that directs light at an object, a sensor that detects the light that is reflected from the object, and a processing unit that calculates the distance to the object based on the round-trip time it takes for the light to travel to and from the object.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A is a functional block diagram of an imaging system capable of generating both color information and depth information, in accordance with embodiments of the disclosure.

FIG. 1B is a simplified block diagram of the imaging system illustrated in FIG. 1A for two-dimensional and three-dimensional imaging, in accordance with an embodiment of the disclosure.

FIG. 1C illustrates one example of a pixel circuit corresponding to a repeat unit of the pixel array illustrated in FIG. 1A and FIG. 1B, in accordance with embodiments of the disclosure.

FIG. 1D illustrates a pixel array with pixels configured to be operated as imaging pixels or time-of-flight pixels, in accordance with an embodiment of the disclosure.

FIG. 1E illustrates a plurality of imaging control lines and a plurality of time-of-flight control lines coupled to transfer gates of individual pixels included in a pixel array to provide independent control of imaging pixels and time-of-flight pixels located on a same row, in accordance with an embodiment of the disclosure.

FIG. 2A illustrates a process 200 for operating pixels of an image sensor as either time-of-flight pixels or imaging pixels, in accordance with an embodiment of the disclosure.

FIG. 2B illustrates an example timing diagram 240 showing integration of time-of-flight pixel cells occurring during a vertical blanking period 242 between sequential readout periods 230-1 and 230-2, in accordance with an embodiment of the disclosure.

FIG. 2C illustrates an example timing diagram in which phase modulation signals have a first phase difference relative to emitted light to define a detection window, in accordance with an embodiment of the disclosure.

FIG. 2D illustrates an example timing diagram in which phase modulation signals have a second phase difference relative to emitted light to define a detection window, in accordance with an embodiment of the disclosure.

FIG. 2E illustrates an example timing diagram for concurrently reading out image signals and time-of-flight signals, in accordance with an embodiment of the disclosure.

FIG. 3 illustrates a pixel array similar to the pixel array illustrated in FIG. 1A-1E that further includes pixel level analog to digital circuitry (ADC) to allow for pixels operated as time-of-flight pixels to occur at any time with respect to pixels operated as imaging pixels, in accordance with an embodiment of the disclosure.

FIG. 4 illustrates a stacked imaging system including a pixel wafer, a logic wafer, and a memory wafer, in accordance with an embodiment of the disclosure.

### DETAILED DESCRIPTION

Embodiments of an apparatus, system, and method each related to an image sensor with a time-of-flight pixel cell are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It will be understood that, although the terms first, second, third, etc., may be used in the disclosure and claims to describe various elements, these elements should not be limited by these terms and should not be used to determine the process sequence or formation order of associated elements. Unless indicated otherwise, these terms are merely used to distinguish one element from another element. Thus, a first element discussed below could be termed a second element without departing from the teachings of the disclosed embodiments.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

Hybrid image sensors capable of generating two-dimensional images and three-dimensional images remain challenging. For example, pixel circuits of time-of-flight cameras capable of generating three-dimensional images are different from pixel circuits of complementary metal-oxide-semiconductor image sensors capable of generating two-dimensional images. Arranging the different pixel circuits within a same sensor area (e.g., in or on a same semiconductor material or a same semiconductor substrate) may result in inefficient space utilization, loss of symmetry, increase in fabrication complexity, reduced image quality, increased cost, and the like.

Embodiments of the disclosure address the challenges of hybrid image sensors by using the same pixel circuits for generating both two-dimensional information (e.g., two-dimensional images or data) and three-dimensional information (e.g., three-dimensional images or data). In some embodiments, rolling shutter pixel circuits, global shutter pixel circuits, pixel circuits with pixel level analog-to-digital converter circuit, or other pixel circuits are utilized for both two-dimensional and three-dimensional imaging. For example, a first set of pixels (e.g., visible pixels) in a pixel array may be used for determining color information describing an object within an external scene while a second set of pixels (e.g., non-visible pixels) included in the pixel array may be used for determining depth or distance information even though both the first set and the second set of pixels have the same base pixel circuit architecture. In such an embodiment, this may be achieved by configuring the second set of pixels to be operated as time-of-flight pixel cells in which individual pixels (e.g., non-visible pixels) included in the pixel array are operated as taps of a time-of-flight pixel cell. For example, two or more non-visible pixels separated from one another by one or more visible pixels may be operated as a multi-tap distributed time-of-flight pixel cell to generate depth information in accordance with embodiments of the disclosure.

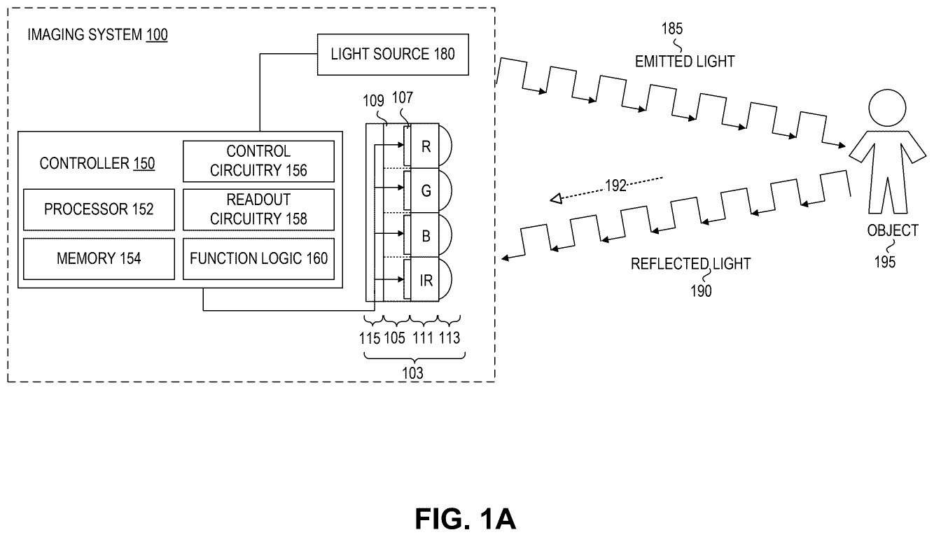

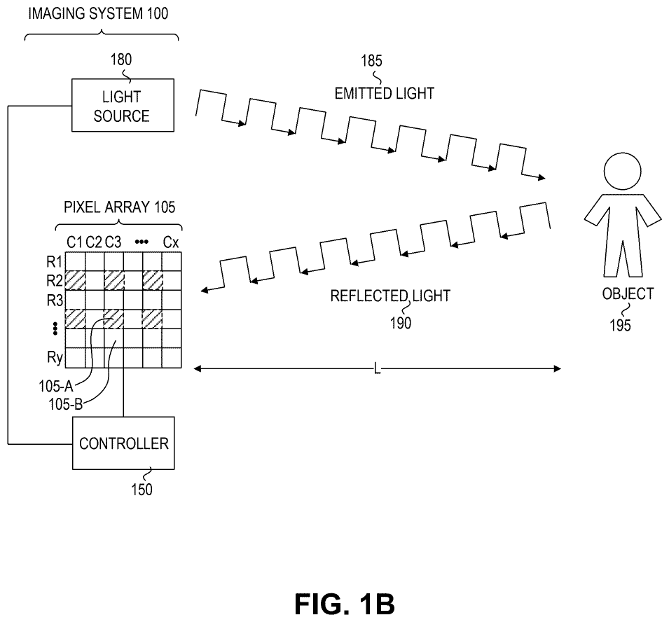

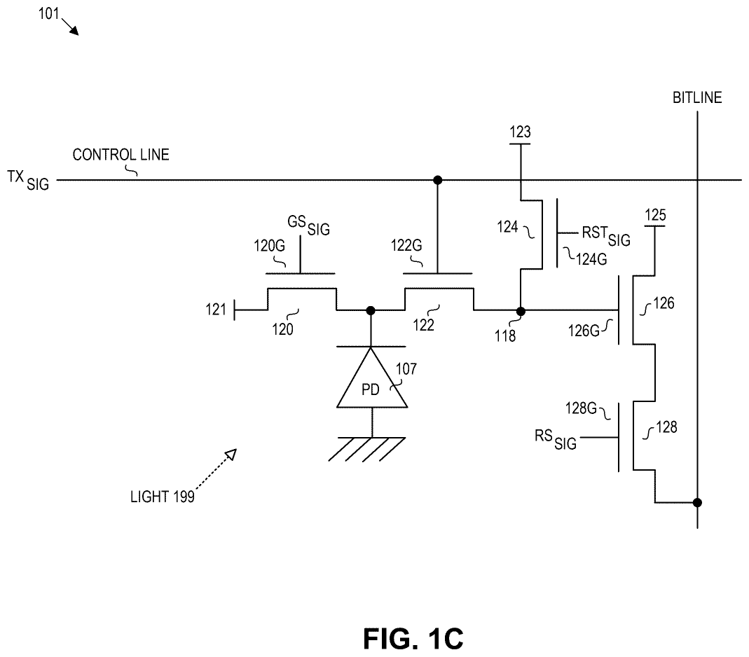

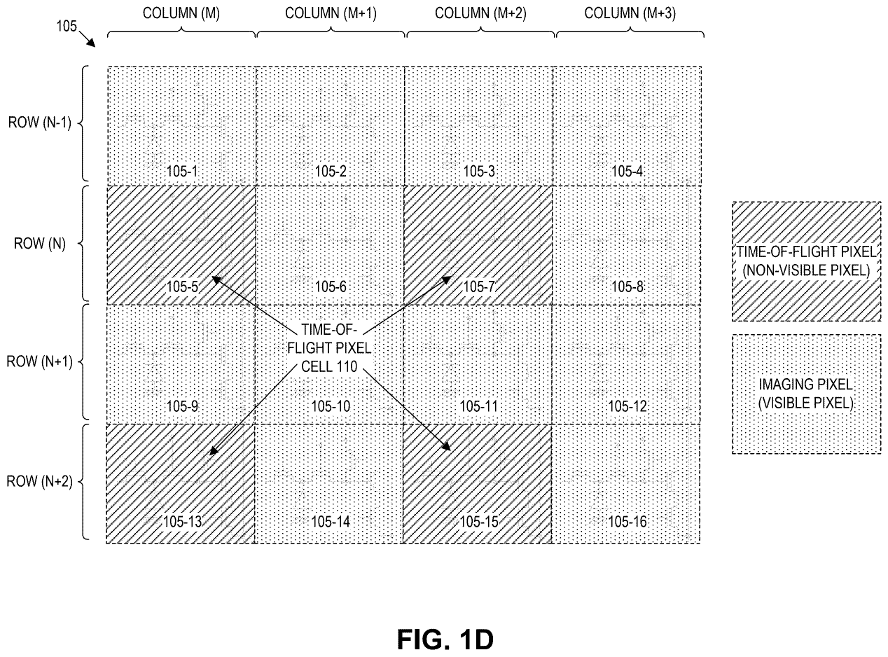

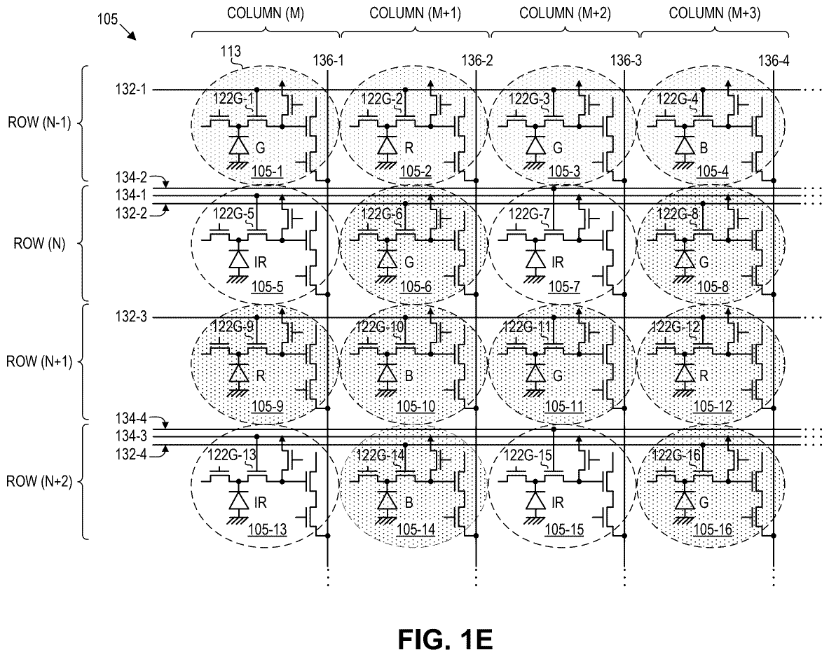

FIG. 1A is a functional block diagram of an imaging system 100 capable of generating both color information and depth information, in accordance with embodiments of the disclosure. In some embodiments, imaging system 100 is a hybrid camera that calculates depth information of a scene (e.g., object 195) based on indirect time-of-flight and color information of the scene (e.g., in the form of two-dimensional images). In some embodiments, imaging system 100 may also be utilized to capture high dynamic range images. Imaging system 100 includes an image sensor 103, a controller 150, and a light source 180. Image sensor 103 includes a pixel array 105 including a plurality of photodiodes 107 having substantially identical configuration formed in or on a semiconductor material 109, a plurality of spectral filters 111 optically aligned with plurality of photodiodes 107, a plurality of microlenses 113 configured to focus or otherwise direct incident light onto pixel array 105, and a metallization region 115 including control lines (e.g., plurality of imaging control lines 132 and plurality of time-of-flight control lines 134 illustrated in FIG. 1E), bitlines (e.g., plurality of bitlines 136 illustrated in FIG. 1E), or other metal wiring for coupling components of image sensor 103 to one another and/or to components or circuitry external to image sensor 103.

In the illustrated embodiment, plurality of spectral filters 111 (e.g., “G” for green, “R” for red, “B” for blue, or “IR” for infrared) disposed between optically aligned photodiodes included in plurality of photodiodes 107 and microlenses included in plurality of microlenses 113 configures individual pixels included in pixel array 105 as a visible pixels (e.g., green, red, or blue) or non-visible pixels (e.g., infrared). In some embodiments, the visible pixels may be utilized to determine color information (e.g., by sensing light 192 representative of a scene represented by object 195) while the non-visible pixels may be utilized to determine depth information (e.g., by sensing reflected light 190 representative of the scene represented by object 195). For example, light 192 may correspond to broad spectrum light including the visible range of the electromagnetic spectrum (e.g., light with a wavelength range from 380 nm to 750 nm) that is sensed, at least in part, by the visible pixels of pixel array 105 to determine color information. In the same embodiment, reflected light 190 may correspond to non-visible light (e.g., infrared light with a wavelength range from 780 nm to 1 mm) that is sensed, at least in part, by non-visible pixels of pixel array 105 to determine depth information. More specifically, controller 150 is configured to synchronize operation of light source 180 (e.g., configured to output emitted light 185 that reflects off object 195 as reflected light 190) with non-visible pixels of pixel array 105 for indirect time-of-flight measurements.

Controller 150 includes one or more processors 152, memory 154, control circuitry 156, readout circuitry 158, and function logic 160. Controller 482 includes logic and/or circuitry to control the operation (e.g., during pre-, post-, and in situ phases of image and/or video acquisition) of the various components of imaging system 100. Controller 150 can be implemented as hardware logic (e.g., application specific integrated circuits, field programmable gate arrays, system-on-chip, etc.), software/firmware logic executed on a general-purpose microcontroller or microprocessor, or a combination of both hardware and software/firmware logic. In one embodiment, controller 150 includes processor 152 coupled to memory 154 that stores instructions for execution by controller 150, processor 152, one or more other components of imaging system 100, or more generally imaging system 100. The instructions, when executed, can cause imaging system 100 to perform operations associated with the various functional modules, logic blocks, or circuitry of imaging system 100 including any one of, or a combination of, control circuitry 156, readout circuitry 158, function logic 160, light source 180, image sensor 103, and/or any other element of imaging system 100 (illustrated or otherwise). Memory 154 is a non-transitory computer-readable medium that can include, without limitation, a volatile (e.g., RAM) or non-volatile (e.g., ROM) storage system readable by controller 150. It is further appreciated that controller 150 can be a monolithic integrated circuit, one or more discrete interconnected electrical components, or a combination thereof, which may be formed on one or more substrates that are coupled together. Additionally, in some embodiments one or more electrical components can be coupled together to collectively function as controller 150 for orchestrating operation of the imaging system 100. It is noted that image sensor 103 and controller 150 are represented as separate components in FIG. 1A for explanation purposes. However, it is appreciated that in some embodiments image sensor 103 and components of controller 150 (e.g., memory 154, control circuitry 156, readout circuitry 158, and the like) may be integrated onto a same integrated circuit chip or wafer in a non-stacked standard planar sensor. In various embodiments, it is also appreciated that imaging system 100, including pixel array 105, may be implemented as a stacked sensor.

Control circuitry 156 can control operational characteristics of pixel array 105 formed by plurality of photodiodes 107 (e.g., exposure duration, when to capture digital images or videos, and the like). In some embodiments, control circuitry 156 corresponds to pixel control circuits illustrated in FIG. 1C. Referring back to FIG. 1A, readout circuitry 158 reads or otherwise samples the analog signal from individual photodiodes (e.g., read out electrical signals based on charge generated by each of plurality of photodiodes 107 in response to reflected light 190 and/or light 192 to determine depth information and/or color information representative of object 195) and can include amplification circuitry, analog-to-digital (ADC) circuitry, sample-and-hold circuitry, image buffers, or otherwise. In the illustrated embodiment, readout circuitry 158 is included in controller 150, but in other embodiments readout circuitry 158 can be separate from controller 150. Function logic 160 is coupled to readout circuitry 158 to receive image data to de-mosaic the image data and generate one or more image frames, calculate distance or depth based on image signals, or the like.

FIG. 1B is a simplified block diagram of imaging system 100 illustrated in FIG. 1A for two-dimensional and three-dimensional imaging, in accordance with an embodiment of the disclosure. As illustrated, imaging system 100 includes light source 180 that is synchronized with a sensor that includes pixel array 105, which includes non-visible pixels 105-A and visible pixels 105-B, and controller 150 that is coupled to control and synchronize pixel array 105 and light source 180. In some embodiments, non-visible pixels 105-A and visible pixels 105-B are configured to have substantially identical structural configurations, pixel circuit configurations, and characteristics. Pixel array 105 includes a plurality of pixels arranged in rows (e.g., a first row “R1,” a second row “R2,” a third row “R3,” and so on) and columns (e.g., a first column “C1,” a second column “C2,” a third column “C3,” and so on). In some embodiments, individual rows are arranged parallel to one another along a first direction and individual columns are arranged parallel to one another along a second direction that is perpendicular to the first direction. In some embodiments, each pixel included in the plurality of pixels of pixel array 105 corresponds to a repeat unit of pixel array 105 that may include or otherwise correspond to a pixel circuit.

As illustrated, light source 180 is configured to emit light 185 to object 195 over a distance L. Emitted light 185 is then reflected from object 195 as reflected light 190 (e.g., reflected light waves/pulses), some of which propagates towards pixel array 105 over the distance L and is incident upon photodiodes included in non-visible pixels 105-A as image light. Pixel circuits of the non-visible pixels included in pixel array 105 are capable of detecting reflected light 190 and converting the reflected light 190 into an electric signal (e.g., electrons, image charge, etc.). More specifically, controller 150 is configured to drive a groups of physically separated non-visible pixels 105-A as time-of-flight pixel cells with multiple taps by applying a TOF signal sequence to the transfer gates included in the groups of non-visible pixels for generating depth information and further configured to drive visible pixels 105-B as imaging pixels by applying an imaging signal sequence to the transfer gates included in the visible pixels for generating color information.

Continuing with the depicted embodiment, time-of-flight pixel cells (e.g., two or more of non-visible pixels 105-A) are operated to determine depth information for a corresponding portion of object 195 (e.g., to generate a 3D image of object 195). While non-visible pixels 105-A and visible pixels 105-B may have corresponding to repeat units having a same pixel circuit, non-visible pixels 105-A are operated in groups of two or more with each individual non-visible pixel included in the group treated as a tap of the time-of-flight pixel cell. Each tap of a given time-of-flight pixel cell has a different phase modulation signal (e.g., 0°, 90°, 180°, 270° or other phase differences with respect to a phase of emitted light 185) to measure the delay/phase difference between emitted light 185 and the received reflected light 190 to indirectly determine a round-trip time for light to propagate from light source 180 to object 195 and back to pixel array 105. In some embodiments, once the round-trip time (i.e., amount of time that it takes for the light to travel to and from object 195) is known, the distance L may be approximated by multiplying the round-trip time by half the speed of light.

As shown in the illustrated embodiment, controller 150 is coupled to pixel array 105 and includes logic and memory that when executed causes imaging system 100 to perform operations for determining the round-trip time. Determining the round-trip time may be based, at least in part, on timing signals generated by controller 150 and applied to the transfer gates of pixel circuits included non-visible pixels 105-A. For indirect time-of-flight measurements, the timing signals are representative of the delay/phase difference between the light waves/pulses corresponding to when light source 180 outputs emitted light 185 and when photodiodes included in non-visible pixels 105-A detect reflected light 190.

It is appreciated that imaging system 100 may be included in a device (e.g., a mobile phone, a tablet, a camera, an automobile or other vehicle, etc.) that has size or power constraints. Alternatively, or in addition, imaging system 100 may have specific desired device parameters such as frame rate, depth resolution, lateral resolution, etc. In some embodiments, imaging system 100 may be used as a hybrid sensor to replace separate two-dimensional and three-dimensional cameras. For example, imaging system 100 may replace a front-facing sensor suite of a vehicle that includes both a two-dimensional camera (e.g., a standard image sensor) and a three-dimensional camera (e.g., lidar or radar based sensors).

FIG. 1C illustrates one example of a pixel circuit 101 corresponding to a repeat unit of pixel array 105 illustrated in FIG. 1A and FIG. 1B, in accordance with embodiments of the disclosure. In some embodiments, each of non-visible pixels 105-A and visible pixels 105-B may correspond to a respective instance of pixel circuit 101. Pixel circuit 101 includes a photodiode 107, a floating diffusion 118, a global shutter transistor 120 including a global shutter gate 120G, a transfer transistor 122 including a transfer gate 122G, a reset transistor 124 including a reset gate 124G, a source-follower transistor 126 including a source follower gate 126G, and a row select transistor 128 including a row select gate 128G. In the illustrated embodiment transistors associated with pixel circuit 101 may be operable (e.g., configurable to an ON or a HIGH state, an OFF or a LOW state, or the like) via control signals (e.g., a voltage or bias) applied or generated by a controller (e.g., controller 150 illustrated in FIG. 1A and FIG. 1B). Control signals include a global shutter control signal GS_{SIG} applied to global shutter gate 120G, a transfer control signal TX_{SIG} applied to transfer gate 122G through the illustrated control line, a reset control signal RST_{SIG} applied to reset gate electrode 124G, and a row select control signal RS_{SIG} applied to row select gate electrode 128G.

Global shutter transistor 120 is coupled between a source 121 (e.g., a voltage source) providing a pixel voltage and photodiode 107 (e.g., a cathode of the photodiode 107). In response to global shutter signal GS_{SIG} applied to global shutter gate 120G, global shutter transistor 120 may be configured to an “ON” state to cause photodiode 107 to be reset to a pre-determined voltage level (e.g., based on source 121). In some embodiments, global shutter transistor 120 is coupled to selectively deplete the image charge that has accumulated in photodiode 107 by selectively coupling photodiode 107 to source 121 in response to global shutter signal GS_{SIG} applied to global shutter gate 120G. Transfer transistor 122 associated with transfer gate electrode 122G is coupled between photodiode 107 and floating diffusion 118. Photodiode 107 is configured to photogenerate and accumulate charge in response to incident light 199 (e.g., reflected light 190 illustrated in FIG. 1A and FIG. 1B or light 192 illustrated in FIG. 1A). Floating diffusion 118 is configured to receive the charge from photodiode 107 in response to transfer control signal TX_{SIG} applied to transfer gate 122G. For example, transfer gate 122G is configured to selectively transfer the charge from photodiode 107 to floating diffusion 118. Reset transistor 124 is coupled between a source 123 (e.g., a voltage source) and floating diffusion 118 to selectively reset floating diffusion 118 to a predetermined voltage level in response to reset signal RST_{SIG} and, optionally, reset photodiode 107 to the predetermined voltage level if transfer transistor 122 is also configured in an “ON” state. Floating diffusion 118 is coupled to source-follower gate electrode 126G. Source-follower transistor 126 is coupled between source 125 (e.g., a voltage source) and row select transistor 128. Source-follower transistor 126 is configured to convert the charge received at source-follower gate electrode 126G from first floating diffusion 118 to a corresponding voltage signal. Row select transistor 128 is configured to send the corresponding voltage signal from the source-follower transistor 126 to a bitline in response to row select control signal RS_{SIG} applied to row select gate 128G. In some embodiments, sources 121, 123, and 125 may correspond to the same source (e.g., a voltage supply VDD) or different sources.

FIG. 1D illustrates pixel array 105 with pixels configured to be operated as imaging pixels or time-of-flight pixels, in accordance with an embodiment of the disclosure. As illustrated, a plurality of pixels (e.g., pixels 105-1, 105-2, 105-3, 105-4, 105-5, 105-6, 105-7, 105-8, 105-9, 105-10, 105-11, 105-12, 105-13, 105-14, 105-15, and 105-16) are arranged in rows and columns to form pixel array 105. In some embodiments, each pixel included in pixel array 105 may correspond to a repeat unit with equivalent pixel circuits. For example, each pixel included in pixel array 105 may correspond to respective instances of pixel circuit 101 illustrated in FIG. 1C. However, in other embodiments, pixel circuits different from pixel circuit 101 may be utilized. For example, 4T, 5T, 6T pixel circuit architectures, global shutter pixels, rolling shutter pixels, and the like may be configured to be operated as either time-of-flight pixels or imaging pixels in accordance with embodiments of the disclosure.

Referring back to FIG. 1D, individual pixels within pixel array 105 are operated as either imaging pixels or time-of-flight pixels (e.g., based on a configuration of control lines and spectral filters). Imaging pixels are operable to generate image signals representative of the amount of charge photogenerated in response to incident light detected. Time-of-flight pixels are operable to determine depth information based on a time delay or phase shift of light reflected from objects. More specifically, groups of two or more nearby non-visible pixels (e.g., pixels 105-5, 105-7, 105-13, and 105-15) may be operated as a time-of-flight pixel cell (e.g., time-of-flight pixel cell 110) in accordance with embodiments of the disclosure. In the illustrated embodiment, time-of-flight pixel cell 110 includes pixels 105-5, 105-7, 105-13, and 105-15 to form a distributed 4-tap time-of-flight pixel cell with each tap associated with a different phase with respect to emitted light (e.g., 0°, 90°, 180°, or 270° phase difference). As illustrated, the non-visible pixels included in time-of-flight pixel cell 110 are separated from one another by a respective one of the visible pixels. More generally, the non-visible pixels capable of being operated as time-of-flight pixel cell 110 are each laterally surrounded by imaging pixels (e.g., pixel 105-7 is laterally surrounded by imaging pixels including visible pixels 105-2, 105-3, 105-4, 105-6 105-8, 105-10, 105-11, and 105-12).

Time-of-flight pixel cell 110 includes pixel 105-5 (e.g., a first non-visible pixel or first time-of-flight pixel) and pixel 105-7 (e.g., a second non-visible pixel or second time-of-flight pixel) each positioned in row “N” (e.g., a first row included in the rows). In the same embodiment, pixel 105-6 (e.g., a first visible pixel or first imaging pixel) and pixel 105-8 (e.g., a second visible pixel or second imaging pixel) are each positioned in row “N” (e.g., the first row). In the same embodiment, pixel 105-6 is disposed between pixels 105-5 and 105-7 within row “N” (e.g., the first visible pixel is disposed between the first non-visible pixel and the second non-visible pixel within the first row).

Pixel array 105 further includes row “N+1” (e.g., a second row included in the rows) and row “N+2” (e.g., a third row included in the rows) with row “N+1” disposed adjacent to and between row “N” and row “N+2.” Time-of-flight pixel cell 110 further includes pixel 105-13 (e.g., a third non-visible pixel or third time-of-flight pixel) and pixel 105-15 (e.g., a fourth non-visible pixel or fourth time-of-flight pixel) positioned in row “N+2.” As illustrated, pixels 105-13 and 105-15 are positioned in a same row (e.g., in the third row corresponding to row “N+2” that is different from the first row corresponding to row “N”) and are separated from one another by pixel 105-14 (e.g., another one of the visible pixels that is positioned in row “N+2”). In the illustrated embodiment, pixel 105-5 (e.g., the first non-visible pixel) and pixel 105-13 (e.g., the third non-visible pixel) are positioned in a same column (e.g., column “M”) included in the columns. In the same embodiment, pixel 105-7 (e.g., the second non-visible pixel) and pixel 105-15 (e.g., the fourth non-visible pixel) are positioned in a same column (e.g., column “M+2”).

In the illustrated embodiment, rows “N−1” and “N+1” respectively form rows of global shutter gate 120G pixels (e.g., a row of imaging pixels including pixels 105-1, 105-2, 105-3, and 105-4 and another row of imaging pixels including pixels 105-9, 105-10, 105-11, and 105-12). In the illustrated embodiment, the row of imaging pixels formed in row “N+1” is disposed adjacently between row “N” (e.g., the first row) and row “N+2” (e.g., the third row). In some embodiments, the row of imaging pixels included in row “N+1” is disposed between pixel 105-5 (e.g., the first time-of-flight pixel) and pixel 105-13 (e.g., the third time-of-flight pixel). In the same embodiment, the row of imaging pixels included in row “N+1” is disposed between pixel 105-7 (e.g., the second time-of-flight pixel) and pixel 105-15 (e.g., the fourth time-of-flight pixel).

In some embodiments, rows “N−1” and “N+1” are referred to as rows of imaging pixels and may only include imaging pixels (e.g., each pixel included in rows “N−1” and “N+1” are exclusively used for generating image signals). However, in other embodiments, rows “N−1” and “N+1” may be referring to rows of imaging pixels that also include time-of-flight pixels (e.g., a first portion of row “N−1” or “N+1” may include two or more directly adjacent imaging pixels that form a row of imaging pixels disposed between time-of-flight pixels included in time-of-flight pixel cell 110 and a second portion of row “N−1” or “N+1” may include one or more time-of-flight pixels that may be operated as one or more time-of-flight pixel cells different from time-of-flight pixel cell 110). For example, a second time-of-flight pixel cell may be offset from time-of-flight pixel cell 110 (e.g., the second time-of-flight pixel cell may be formed from time-of-flight pixels included in rows “N−1” and “N+1”).

It is appreciated that while time-of-flight pixel cell 110 is a distributed cell that may have individual non-visible or time-of-flight pixels separated from one another in different rows or columns by one or more visible or imaging pixels, each of the pixels included in time-of-flight pixel cell 110 (e.g., pixels 105-5, 105-7, 105-13, and 105-15) are independently controllable even if the non-visible pixels are positioned in the same column or row of pixel array 105. In such a manner the transfer transistor of pixels operated as a time-of-flight pixel cell 110 may be independently turned on or off (e.g., to apply different phase modulation signals dictating when to sense reflected light). Individual pixels operated collectively as a time-of-flight pixel cell are subsequently able to be treated as respective taps of the time-of-flight pixel cell to determine depth information.

FIG. 1E illustrates a plurality of imaging control lines 132 and a plurality of time-of-flight control lines 134 coupled to transfer gates of individual pixels included in pixel array 105 to provide independent control of imaging pixels and time-of-flight pixels located on a same row, in accordance with an embodiment of the disclosure. In the illustrated embodiment, the photodiode of each pixel included in pixel array 105 is denoted to indicate the spectral filter (e.g., “G” for green, “R” for red, “B” for blue, or “IR” for infrared) disposed between the photodiode and a corresponding one of the plurality of microlenses 113 that configures individual pixels as a visible pixel (e.g., green, red, or blue) or non-visible pixel (e.g., infrared). It is noted that individual microlenses included in plurality of microlenses 113 are shaped to direct light toward the underlying photodiode include in a given pixel and the spectral filter is configured to primarily transmit light within a predetermined wavelength range while reflecting, absorbing, or otherwise attenuating light outside of the predetermined wavelength range. For example, a “red” spectral filter will transmit red light (e.g., light with a wavelength from approximately 620 nm to 750 nm) to the underlying photodiode while attenuating light that is not within the predetermined wavelength range of red light.

In the illustrated embodiment, plurality of imaging control lines 132 (e.g., 132-1, 132-2, 132-3, and 132-4) are coupled to the transfer gate (e.g., 122G-1, 122G-2, 122G-3, 122G-4, 122G-6, 122G-8, 122G-9, 122G-10, 122G-11, 122G-12, 122G-14, and 122G-16) of each of the visible pixels (e.g., pixels 105-1, 105-2, 105-3, 105-4, 105-6, 105-8, 105-9, 105-10, 105-11, 105-12, 105-14, and 105-16) included in pixel array 105 to configure the visible pixels as imaging pixels. In the same embodiment, plurality of time-of-flight control lines 134 (e.g., 134-1, 134-2, 134-3, and 134-4) are coupled to the transfer gate (e.g., 122G-5, 122G-7, 122G-13, and 122G-15) of each of the non-visible pixels (e.g., 105-5, 105-7, 105-13, and 105-15) included in pixel array 105 to configure the non-visible pixels as time-of-flight pixels. It is appreciated that having plurality of imaging control lines 132 separate from plurality of time-of-flight control lines 134 allows for driving the visible pixels as imaging pixels separately from driving the non-visible pixels as time-of-flight pixel cells.

In the illustrated embodiment, rows with multiple time-of-flight pixels (e.g., row “N” and row “N+2”) include two or more control lines included in plurality of time-of-flight control lines 134 to configure the time-of-flight pixels as time-of-flight pixel cells. As will be discussed subsequently in greater detail, multiple time-of-flight control lines associated with a same row (e.g., time-of-flight control lines 134-1 and 134-2 are both associated with row “N”) enables groups of nearby time-of-flight pixels to be operated as a distributed multi-tap time-of-flight pixel cell for increased accuracy in depth or distance measurement. For example, plurality of time-of-flight control lines 134 enables pixels 105-5, 105-7, 105-13, and 105-15 to be operated collectively as a 4-tap time-of-flight pixel cell to more accurately determine a phase difference between emitted light and reflected light. In other words, time-of-flight control lines 134-1, 134-2, 134-3, and 134-4 respectively allow for pixels 105-5, 105-7, 105-13, and 105-15 to be sequentially or otherwise independently operated such that the transfer gate, the photodiode, and the floating diffusion of pixels 105-5, 105-7, 105-13, and 105-15 may be treated as respective taps of a time-of-flight pixel cell.

In the same or other embodiments, groups of non-visible pixels may be operated as time-of-flight pixel cells with fewer or greater taps using plurality of time-of-flight control lines 134. In some embodiments, pixels 105-5, 105-7, 105-13, and 105-15 may be operated as two separate 2-tap time-of-flight pixel cells. For example, in one embodiment, pixels 105-5 and 105-7 may be operated as a first time-of-flight pixel cell and pixels 105-13 and 105-15 may be operated as a second time-of-flight pixel cell. In another embodiment, pixels 105-5 and 105-13 may be operated as a first time-of-flight pixel cell and pixels 105-7 and 105-15 may be operated as a second time-of-flight pixel cell. In yet another embodiment, pixels 105-5 and 105-15 may be operated as a first time-of-flight pixel cell and pixels 105-7 and 105-13 may be operated as a second time-of-flight pixel cell. Put in another way, nearby non-visible pixels that are row adjacent, column adjacent, or diagonal adjacent may be operated collectively as distributed time-of-flight pixel cells. In some embodiments, pixels 105-5, 105-7, 105-13, and 105-15 may be operated as a time-of-flight pixel cell with more than 4-taps. For example, if pixel array 105 is expanded to include additional rows, nearby non-visible pixels (e.g., included in columns “M” and “M+2”) may be operated in sequence with pixels 105-5, 105-7, 105-13, and 105-15 as a multi-tap time-of-flight pixel cell with 6 or more taps.

As illustrated, plurality of imaging control lines 132 and plurality of time-of-flight control lines 134 are coupled to transfer gates of pixels included in pixel array 105 on a row-by-row basis, which is opposite to the column-by-column basis plurality of bitlines 136 is coupled to the row select transistor of pixels included in pixel array 105. Imaging control line 132-1 is associated with row “N−1” and is coupled to transfer gates 122G-1, 122G-2, 122G-3, and 122G-4 of pixels 105-1, 105-2, 105-3, and 105-4. Imaging control line 132-2 is associated with row “N” and is coupled to transfer gates 122G-6 and 122G-8 of pixels 105-6 and 105-8. In some embodiments, imaging control line 132-2 is positioned or otherwise disposed adjacent to at least one of time-of-flight control lines 134-1 or 134-2. In some embodiments, imaging control line 132-2 is positioned between time-of-flight control lines 134-1 and 134-2. Imaging control line 132-3 is associated with row “N+1” and is coupled to transfer gates 122G-9, 122G-10, 122G-11, and 122G-12 of pixels 105-9, 105-10, 105-11, and 105-12. Imaging control line 132-4 is associated with row “N+2” and is coupled to transfer gates 122G-14 and 122G-16 of pixels 105-14 and 105-16. Time-of-flight control line 134-1 is associated with row “N” and is coupled to transfer gate 105G-5 of pixel 105-5. Time-of-flight control line 134-2 is associated with row “N” and is coupled to transfer gate 105G-7 of pixel 105-7. Time-of-flight control line 134-3 is associated with row “N+2” and is coupled to transfer gate 105G-13 of pixel 105-13. Time-of-flight control line 134-4 is associated with row “N+2” and is coupled to transfer gate 105G-15 of pixel 105-15. Bitline 136-1 is associated with column “M” and coupled to the row select transistor of pixels 105-1, 105-5, 105-9, and 105-13. Bitline 136-2 is associated with column “M+1” and coupled to the row select transistor of pixels 105-2, 105-6, 105-10, and 105-14. Bitline 136-3 is associated with column “M+2” and coupled to the row select transistor of pixels 105-3, 105-7, 105-11, and 105-15. Bitline 136-4 is associated with column “M+3” and coupled to the row select transistor of pixels 105-4, 105-8, 105-12, and 105-16.

In some embodiments, pixel array 105 may include additional rows and/or columns of pixels, which may be configured as visible pixels or non-visible pixels depending on the target specification of the image sensor. The transfer gates of the additional visible pixels and/or non-visible pixels may then be appropriately coupled to plurality of imaging control lines 132 or plurality of time-of-flight control lines 134 since the control lines extend on a row-by-row basis. For example, imaging control line 132-2 may be coupled to the transfer gate of every visible pixel included in row “N”. In the same or other embodiment, the transfer gate of each non-visible pixel included in row “N” may be coupled to either time-of-flight control lines 134-1 or 134-2 in an alternating manner. Similarly, row select transistors of the additional visible pixels and/or non-visible pixels may be appropriately coupled to plurality of bitlines 136.

In some embodiments, the illustrated view of 16 pixels configured to have one distributed time-of-flight pixel cell (e.g., based on the configuration of plurality of time-of-flight control lines 134) may be repeated throughout pixel array 105 such that every group of 16 pixels includes a corresponding distributed time-of-flight pixel cell. However, in other embodiments, time-of-flight pixel cells may be more sparsely distributed (e.g., 1 time-of-flight pixel cell included in every 32 pixels, 1 time-of-flight pixel cell included in every 64 pixels, or a greater ratio depending on a target specification of the image sensor).

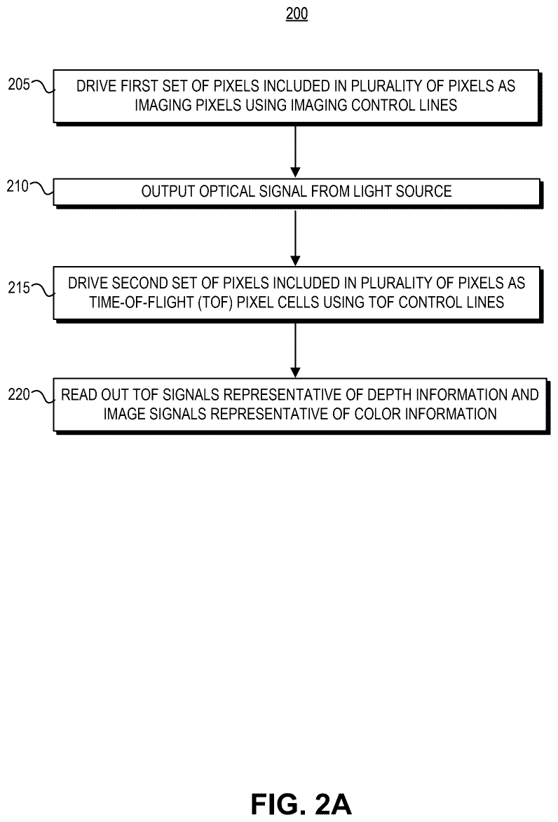

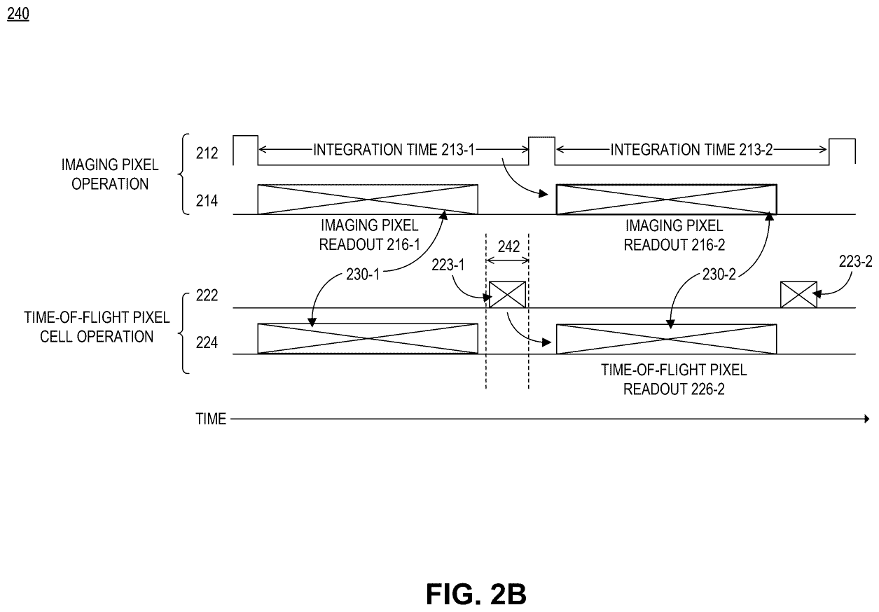

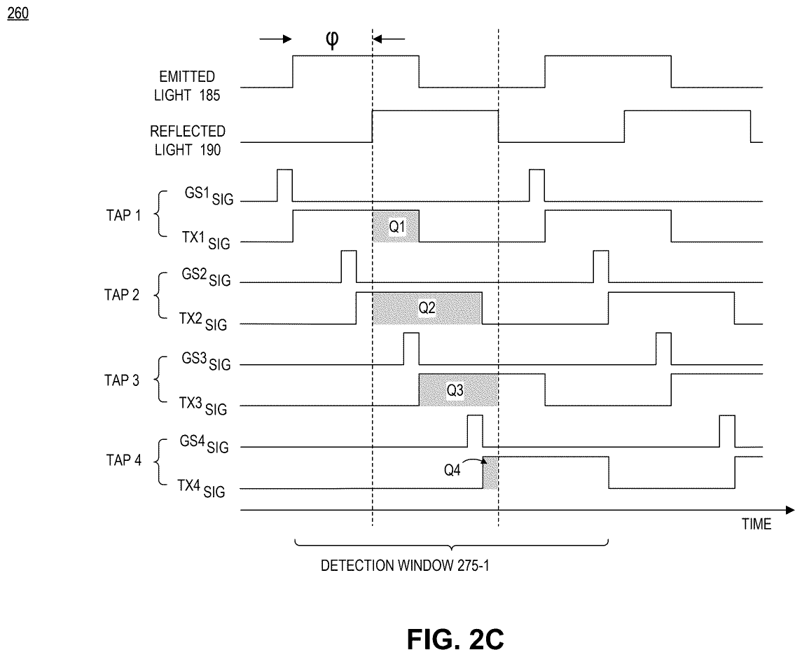

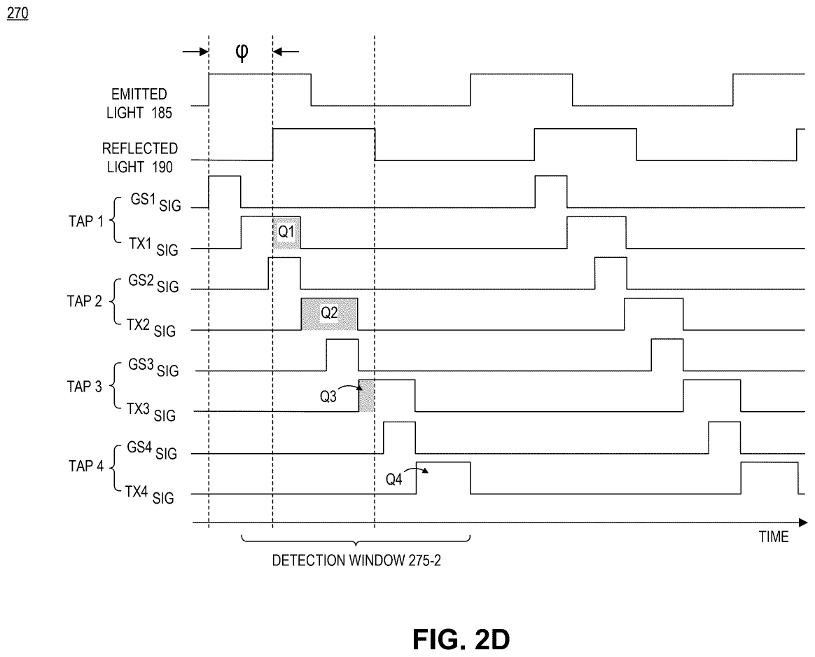

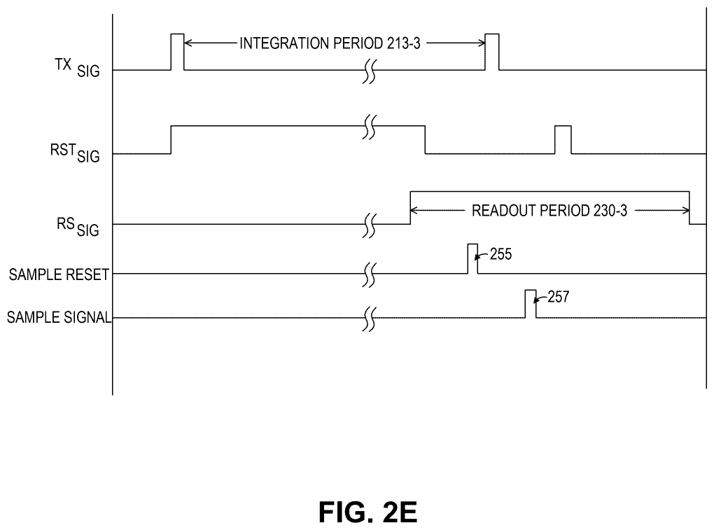

FIG. 2A illustrates a process 200 for operating pixels of an image sensor as either time-of-flight pixels or imaging pixels, in accordance with an embodiment of the disclosure. Process 200 is one possible way to drive imaging system 100 illustrated in FIG. 1A-1E as a hybrid image sensor to capture both two-dimensional information (e.g., color information) and three-dimensional information (depth or distance information). The order in which some or all of the process blocks appear in process 200, which includes blocks 205, 210, 215, and 220 should not be deemed limiting. Rather, one of ordinary skill in the art having the benefit of the present disclosure will understand that some of the process blocks may be executed in a variety of orders not illustrated, or even in parallel.

Block 205 illustrates driving a first set of pixels included in a plurality of pixels (e.g., visible pixels included in pixel array 105 illustrated in FIG. 1D and FIG. 1E) as imaging pixels using imaging control lines (e.g., plurality of imaging control lines 132 illustrated in FIG. 1E). In some embodiments, the first set of pixels are driven according to an imaging signal sequence in which visible photodiodes and floating diffusions are reset, visible photodiodes are configured to accumulate charge in response to incident light (e.g., broad spectrum light such as light 192 illustrated in FIG. 1A), the accumulated charge is transferred to the floating diffusion for storage, and the transferred charge is readout as an electrical signal (e.g., an image signal representative of color information) through a bitline. In some embodiments, “driving” imaging pixels refers to applying an appropriate signal on the imaging control lines (e.g., plurality of imaging control lines 132 illustrated in FIG. 1E) coupled to transfer gates of the visible pixels to selectively transfer accumulated charge to a floating diffusion for generating color information. It is appreciated that operation of the visible pixels may include additional signals (e.g., a global shutter signal applied to global shutter gate, a reset signal applied to a reset gate, and a row select signal applied to a row select gate as illustrated in FIG. 1C or other signals depending on a configuration of the pixel circuit included in each of the pixels of the pixel array).

Block 210 shows outputting an optical signal from a light source (e.g., a light emitting diode or laser such as light source 180 illustrated in FIG. 1A is driven to emit light). In some embodiments, the light source emits infrared light that may be reflected off an object representative of or included in an external scene to be incident on the pixel array as reflected light (e.g., reflected light 190 illustrated in FIG. 1A and FIG. 1B).

Block 215 illustrated driving a second set of pixels included in a plurality of pixels (e.g., non-visible or time-of-flight pixels included in pixel array 105 illustrated in FIG. 1D and FIG. 1E) as time-of-flight pixel cells using time-of-flight control lines (e.g., plurality of time-of-flight control lines 134 illustrated in FIG. 1E). In some embodiments, the second set of pixels is grouped in subsets of two or more non-visible pixels that are nearby one another and operated as multi-tap time-of-flight pixel cells by applying a time-of-flight signal sequence to the transfer gate included in the non-visible pixels for generating depth information (e.g., distance from a particular point on an object or within an external scene and a subset of two or more non-visible pixels that are being operated a multi-tap time-of-flight pixel cell).

In some embodiments, the time-of-flight signal sequence applied to individual pixels of a given time-of-flight pixel cell includes applying different phase modulation signals to the transfer gate of the individual pixels being operated as the given time-of-flight pixel cell to sequentially turn on the transfer transistors such that there are different phase differences between the emitted light and the modulation signals. For example, a first non-visible pixel and a second non-visible pixel may be operated as a multi-tap time-of-flight pixel cell (e.g., 2-tap, 4-tap, or more). In such an embodiment, block 215 includes applying a first phase modulation signal to the transfer gate of the first non-visible pixel included in the first time-of-flight pixel cell through a first time-of-flight control line and applying second phase modulation signal to the transfer gate of the second non-visible pixel included in the first time-of-flight pixel cell through a second time-of-flight control line. In some embodiments, the first phase modulation signal is out of phase with respect to the second phase modulation signal. For example, the first phase modulation signal may have a 0° phase difference with respect to the emitted light and the second phase modulation signal may have a 180° phase difference with respect to the emitted light. In other embodiments, different phase differences may be utilized (e.g., 90° phase difference with respect to the emitted light, 270° phase difference with respect to the emitted light, and the like). In some embodiments, the second phase modulation signal is the inverse of the first phase modulation signal.

In some embodiments, the second set of pixels are driven according to a time-of-flight signal sequence in which non-visible photodiodes and floating diffusions are reset, non-visible photodiodes included in a given time-of-flight pixel cell are configured to sequentially accumulate charge in response to incident light (e.g., infrared light such as reflected light 190 illustrated in FIG. 1A and FIG. 1B), the accumulated charge is transferred to the floating diffusion for storage, and the transferred charge is readout as an electrical signal (e.g., a time-of-flight signal representative of distance information) through a bitline. In some embodiments, “driving” time-of-flight pixels refers to applying an appropriate signal on the time-of-flight control lines coupled to transfer gates of the non-visible pixels to selectively and sequentially accumulate charge and transfer the accumulated charge to a floating diffusion for generating distance information. In one embodiment, a time-of-flight pixel cell includes a first non-visible pixel, a second non-visible pixel, a third non-visible pixel, and a fourth non-visible pixel (e.g., as illustrated in FIG. 1D) and the time-of-flight signal sequence includes sequentially applying pulses to the transfer gate of the first non-visible pixel, the second non-visible pixel, the third non-visible pixel, and the fourth non-visible pixel included in the time-of-flight pixel cell to turn on pulse on the transfer transistors of the first non-visible pixel, the second non-visible pixel, the third non-visible pixel, and the fourth non-visible pixel included in the time-of-flight pixel cell. In some embodiments, individual pulses included in the pulses do not overlap such that charge accumulation and transfer for each of the first non-visible pixel, the second non-visible pixel, the third non-visible pixel, and the fourth non-visible pixel occur during different time periods to define a detection window for sensing reflected light.

It is appreciated that operation of the non-visible pixels may include additional signals (e.g., a global shutter signal applied to global shutter gate, a reset signal applied to a reset gate, and a row select signal applied to a row select gate as illustrated in FIG. 1C or other signals depending on a configuration of the pixel circuit included in each of the pixels of the pixel array).

It is appreciated that in some embodiments, operation of the visible pixels as imaging pixels and the non-visible pixels as time-of-flight pixel cells may occur separately, concurrently, or a combination thereof. Specifically, the visible pixels are driven as the imaging pixels separately from driving the non-visible pixels as time-of-flight pixel cells using separate control lines (e.g., plurality of imaging control lines that are separate from plurality of time-of-flight control lines). For example, in some embodiments, accumulation of charge (e.g., integration) may occur at different times or otherwise have different durations that overlap (e.g., a first integration time period for imaging pixels is greater than a second integration time period for time-of-flight pixel cells) while readout of the image signals and time-of-flight signals may occur concurrently. In one embodiment, integration of time-of-flight pixel cells may occur during a vertical blanking period. For example, the time-of-flight signal sequence for the time-of-flight pixel cells may be applied between a vertical blanking period that occurs between sequential readout time periods of the plurality of visible or imaging pixels.

Block 220 shows reading out time-of-flight signals representative of depth information and image signals representative of color information. It is appreciated that in some embodiments, the depth information and color information may be respectively used to generate three-dimensional images and two-dimensional images. In some embodiments, a row select signal is applied to the row select transistor of each pixel to readout the image signals and time-of-flight signals. In some embodiments, block 220 includes concurrently reading out time-of-flight signals representative of the depth information and image signals representative of the color information from the floating diffusion included in the plurality of pixels.

FIG. 2B illustrates an example timing diagram 240 showing integration of time-of-flight pixel cells occurring during a vertical blanking period 242 between sequential readout periods 230-1 and 230-2, in accordance with an embodiment of the disclosure. In the illustrated embodiment, segment 212 shows when to drive visible pixels as imaging pixels by applying an imaging signal sequence to the transfer gate of the visible pixels while segment 222 shows when to drive non-visible pixels as time-of-flight pixel cells by applying a time-of-flight signal sequent to the transfer gates of the non-visible pixels. It is appreciated that the imaging signal sequence and the time-of-flight signal sequence may result in accumulation of charge that may be subsequently transferred to the corresponding floating diffusion and respectively readout as image signals or time-of-flight signals for generating color information and depth information. In the same embodiment, segment 214 shows when readout of imaging signals occurs while segment 224 shows when readout of time-of-flight signals occurs. In the illustrated embodiment, integration time 213-1 corresponds to a period for accumulating photogenerated charge for imaging pixels representative of a first image frame (e.g., based on first color information) while integration time 213-2 corresponds to a period for accumulating photogenerated charge for imaging pixels representative of a second image frame (e.g., based on second color information) that sequential to the first image frame. In the same embodiment, integration for time-of-flight pixel cells may occur during periods 223-1 and 223-2 for first and second time-of-flight images, respectively.

In the illustrated embodiment, time-of-flight signals representative of depth information and image signals representative of color information are readout from respective floating diffusion included in the plurality of pixels (e.g., based on an appropriate row select signal applied). For example, readout period 230-1 includes both imaging pixel readout 216-1 and time-of-flight pixel readout 226-1. Similarly, readout period 230-2 includes both imaging pixel readout 216-2 and time-of-flight pixel readout 226-2. In some embodiments, the time-of-flight signal sequence applied to the transfer gate of the time-of-flight pixels to drive the time-of-flight pixels as time-of-flight pixel cells occurs during vertical blanking period 242. Vertical blanking period 242 corresponds to a break between readout time periods of sequential frames (e.g., containing color information and/or depth information).

FIGS. 2C and 2D illustrate example timing diagrams 260 and 270 of applying a time-of-flight signal sequence to operate pixels as time-of-flight pixel cells, in accordance with embodiments of the disclosure. Timing diagrams 260 and 270 represent two example ways to drive (e.g., with a controller configured to control operation of a time-of-flight pixel cell such as controller 150 illustrated in FIG. 1A and FIG. 1B) a group of four non-visible pixels included in a pixel array (e.g., pixel array 105 illustrated in FIG. 1A-1E where each pixel may correspond to a repeat unit such as pixel circuit 101 illustrated in FIG. 1C) as a distributed 4-tap time-of-flight pixel cell by applying the appropriate signals to the global shutter gate (e.g., global shutter gate 120G illustrated in FIG. 1C) and transfer gate (e.g. transfer gate 122G illustrated in FIG. 1C). Referring back to FIGS. 2C and 2D, signals applied to the global shutter gate and transfer gate are suffixed with 1, 2, 3, or 4 to represent a first, second, third, and fourth pixel being operated as a time-of-flight pixel cell. For example, pixels 105-5, 105-7, 105-13, and 105-15 that form time-of-flight pixel cell 110 illustrated in FIG. 1D may respectively correspond to a first non-visible pixel, a second non-visible pixel, a third non-visible pixel, and a fourth non-visible pixel that have the signals suffixed with 1, 2, 3, or 4 of timing diagrams 260 and 270 applied to their corresponding global shutter gates and transfer gates through the appropriate control lines.

Timing diagrams 260 and 270 illustrate the timing relationship between example light pulses emitted from a light source relative to the receipt of the reflected light pulses and measurements using various phase shifts. In other words, timing diagrams 260 and 270 provide examples of time-of-flight signal sequences for operating a plurality of pixels as a time-of-flight pixel cell, in accordance with embodiments of the disclosure. Specifically, FIG. 2C and FIG. 2D show emitted light 185, which represents the modulated light pulses that are emitted from the light source 180 to object 195, and reflected light 190, which represents the reflected light pulses that are reflected from object 195 and received by non-visible pixels of pixel array 105 of imaging system 100 illustrated in FIG. 1.

As illustrated in FIG. 2C and FIG. 2D, TX1_{SIG}, TX2_{SIG}, TX3_{SIG}, and TX4_{SIG} each correspond to phase modulation signals having pulses that correspond to the switching or modulation of transfer transistors that are included in each pixel of pixel array 105 while GS1_{SIG}, GS2_{SIG}, GS3_{SIG}, and GS4_{SIG} each correspond respective global shutter signals with pulses that correspond to the switching or modulation of the global shutter transistors included in each pixel of pixel array 105. In some embodiments, each global shutter transistor is turned on for a pre-determined time period via global shutter signals GS1_{SIG}, GS2_{SIG}, GS3_{SIG}, and GS4_{SIG} before turning on the respective transfer transistors to reset corresponding photodiodes to a pre-determined voltage. In other words, in the illustrated timing diagrams 260 and 270, the global shutter transistors transition from an on state to an off state at the same time the respective transfer transistor transitions from an off state to an on state. In the same embodiments, the transfer transistors are turned in sequence to define detection windows 275-1 and 275-2 for detecting reflected light 190 since the integration period for the associated pixels correspond to the duration the transfer transistors are turned on.

In some embodiments, phase modulation signals TX1_{SIG}, TX2_{SIG}, TX3_{SIG}, and TX4_{SIG} may be applied to the transfer gate of the respective non-visible pixels being operated as a time-of-flight pixel cell through the appropriate control line. For example, if pixels 105-5 and 105-7 of FIG. 1E are respectively considered first and second non-visible pixels included in a first time-of-flight pixel cell, then a first phase modulation signal (e.g., TX1_{SIG}) is applied to the transfer gate of pixel 105-5 through time-of-flight control line 134-1 and a second phase modulation signal is applied to the transfer gate of pixel 105-7 through time-of-flight control line 134-2. In the illustrated embodiments, the first phase modulation signal and the second phase modulation signal are out of phase (e.g., 90° out of phase, but in other embodiment different combinations of phases may be utilized). More generally, it is appreciated that the sequence of modulation signals demonstrated by example timing diagrams 260 and 270 illustrates an example of driving the non-visible pixels as time-of-flight pixel cells with multiple taps by applying a time-of-flight signal sequence to the transfer gate included in the non-visible pixels for generating depth information.

In operation, the modulation of the transfer transistors by applying the time-of-flight signal sequence to the non-visible pixels being operated as a time-of-flight pixel cell can be used to measure the charge that is photogenerated in one or more photodiodes that are included in each the non-visible pixels (e.g., the first, second, third, and fourth pixels that are being operated as a time-of-flight pixel cell) in response to the reflected light 190 to measure the delay or phase difference o between the pulses of emitted light 185 and the corresponding pulses of reflected light 190.

Timing diagrams 260 and 270 shows that different amounts of charge are accumulated and transferred to the respective floating diffusions of the first, second, third, and fourth pixels of the time-of-flight pixel cell. The different amounts of charge are respectively referred to as first charges Q1, second charges Q2, third charges Q3, and fourth charges Q4 and are based on phase differences between the phase modulation signals (e.g., TX1_{SIG}, TX2_{SIG}, TX3_{SIG}, and TX4_{SIG}) and emitted light 185. More specifically, first charges Q1, second charges Q2, third charges Q3, and fourth charges Q4 are represented as shaded regions that correspond to when a given time-of-flight pixel included in the time-of-flight pixel cell detects reflected light 190 (e.g., the period of time when a given transfer gate associated with the transfer transistor of a given time-of-flight pixel is on and reflected light 190 is received by the given time-of-flight pixel). The measurements of first charges Q1, second charges Q2, third charges Q3, and fourth charges Q4 can then be used to determine the delay or phase difference φ between the emitted light 185 and the reflected light 190, and therefore the time of flight of light from the light source 180 to object 195 and then back to pixel array 105, in accordance with embodiments of the disclosure.

It is appreciated that in some embodiments, phase modulation signals TX1_{SIG}, TX2_{SIG}, TX3_{SIG}, and TX4_{SIG} may have the same frequency of pulses as emitted light 185 and reflected light 190 for homodyne detection of reflected light 190. In other embodiments, the modulation frequency of the phase modulation signals and emitted light 185 may be varied to include measurements at additional frequencies and/or phases that may improve systematic errors, such as harmonic distortions and/or multipath artifacts. Utilizing different phases for the example measurement pulses as shown allows reconstruction of the encoded distance, in accordance with embodiments of the disclosure.

FIG. 2C illustrates example timing diagram 260 in which phase modulation signals TX1_{SIG}, TX2_{SIG}, TX3_{SIG}, and TX4_{SIG} with 0°, 90°, 180°, and 270° phase difference relative to emitted light 185 to define detection window 275-1, in accordance with an embodiment of the disclosure. In the illustrated embodiment, modulation signal TX3_{SIG} is inverted relative to modulation signal TX1_{SIG}. In the same or other embodiments, modulation signal TX4_{SIG} is inverted relative to modulation signal TX2_{SIG}. It is noted that in the illustrated embodiment of FIG. 2C, GS1_{SIG} pulses before a corresponding pulse of emitted light 185 so that phase modulation signal TX1_{SIG} is in phase (e.g., 0° phase difference) with emitted light 185. In some embodiments, it is appreciated that the sequential pulses applied to the transfer gates to operate the non-visible pixels as time-of-flight pixel cells overlap with at least one other pulse (e.g., at any given time within detection window 275-1 at least two of the transfer transistors for non-visible pixels within a given time-of-flight pixel cell are on for a 4-tap time-of-flight pixel cell).

FIG. 2D illustrates example timing diagram 270 in which phase modulation signals TX1_{SIG}, TX2_{SIG}, TX3_{SIG}, and TX4_{SIG} have arbitrary phase differences relative to emitted light 185 to define detection window 275-2. In the illustrated embodiment, GS1_{SIG} initially pulses at the same time as emitted light 185 so that phase modulation signal TX1_{SIG} is out of phase with emitted light 185. Timing diagram 270 illustrates sequentially applying pulses to the transfer gate of the first non-visible pixel (e.g., via TX1_{SIG}), the second non-visible pixel (e.g., via TX2_{SIG}), the third non-visible pixel (e.g., via TX3_{SIG}), and the fourth non-visible pixel (e.g., via TX4_{SIG}) included in the time-of-flight pixel cell. In some embodiments, it is appreciated that the sequential pulses applied to the transfer gates to operate the non-visible pixels as time-of-flight pixel cells do not overlap any other phase modulation pulse (e.g., at any given time within detection window 275-2 only one of the transfer transistors for non-visible pixels within a given time-of-flight pixel cell is on).

FIG. 2E illustrates an example timing diagram 276 for concurrently reading out image signals and time-of-flight signals, in accordance with an embodiment of the disclosure. Timing diagram 276 shows driving the visible pixels as imaging pixels by applying an imaging signal sequence (e.g., TX_{SIG}) to the transfer gate included in the visible pixels on a row-by-row basis for generating color information. Timing diagram 276 further shows an example reset signal RST_{SIG} for resetting the corresponding photodiode and floating diffusion of a given pixel and an example row select signal RS_{SIG} to define readout period 230-3 for reading out a given row that includes pixels operated as imaging pixels and/or pixels operated as time-of-flight pixel cells. In some embodiments, pulses 255 and 257 provide examples of when to sample voltages to determine a reset signal voltage level (e.g., after reset signal RST_{SIG} is pulsed to reset a corresponding photodiode and floating diffusion) and a total signal voltage level for correlated double-sampling operation. In some embodiments, the difference between the total signal voltage and the reset signal voltage may be used to determine color or depth information for a given imaging pixel or time-of-flight pixel cell.

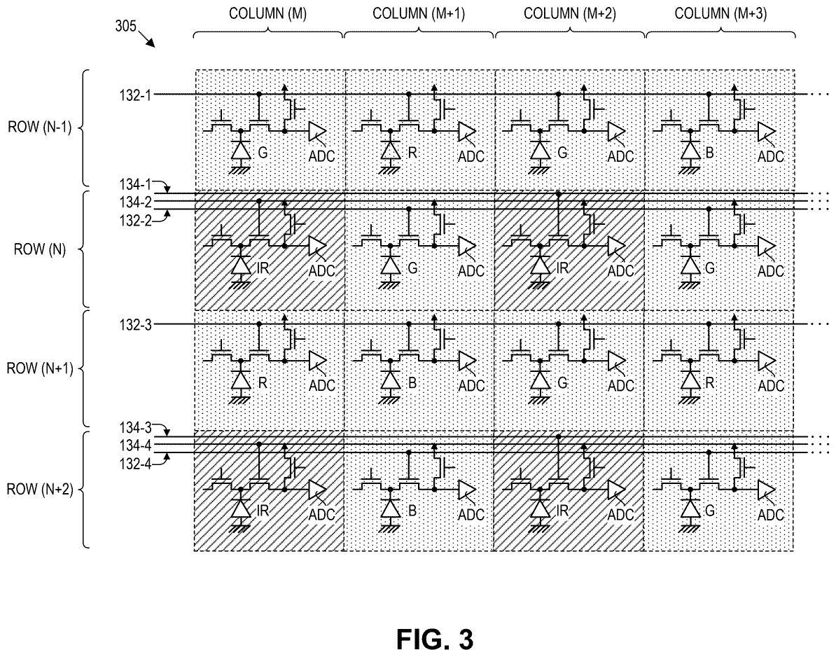

FIG. 3 illustrates a pixel array 305 similar to pixel array 105 illustrated in FIG. 1A-1E that further includes pixel level analog to digital converter (ADC) circuitry to allow for pixels operated as time-of-flight pixels to occur at any time with respect to pixels operated as imaging pixels, in accordance with an embodiment of the disclosure. In other words, in some embodiments operation of pixels as time-of-flight pixel cells may occur at time periods other than a vertical blanking period between readout of sequential frames, for example, by utilizing column level ADC circuitry.

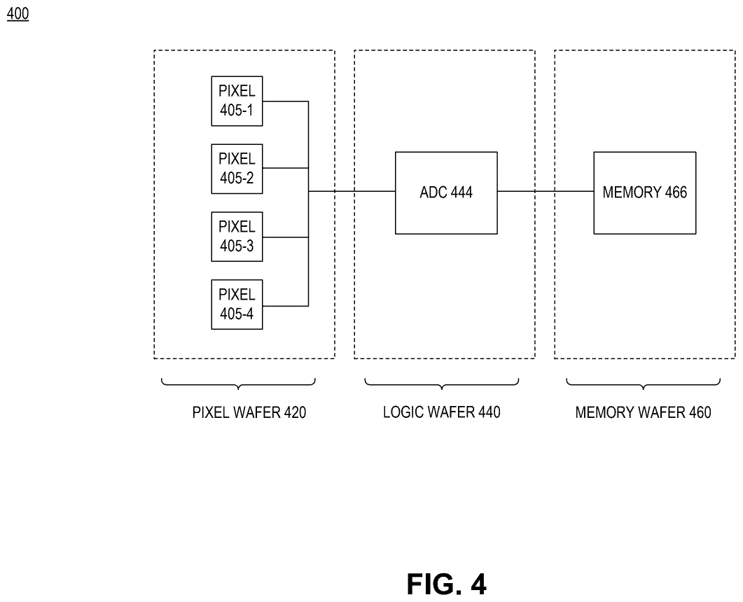

FIG. 4 illustrates a stacked imaging system 400 including a pixel wafer 420, a logic wafer 440 containing analog-to-digital converter (ADC) circuities, and a memory wafer 460, in accordance with an embodiment of the disclosure. Imaging system 400 is one possible way to implement imaging system 100 illustrated in FIG. 1A-1E as a stacked imaging system capable of concurrently applying time-of-flight signal sequences for operating non-visible pixels (e.g., one or more of pixels 405-1, 405-2, 405-3, 405-4 or other pixels included in pixel wafer 420) as time-of-flight pixel cells and applying imaging signal sequences for operating visible pixels (e.g., one or more of pixels 405-1, 405-2, 405-3, 405-4 or other pixels included in pixel wafer 420) as imaging pixels. It is appreciated that 405-1, 405-2, 405-3, 405-4 or other pixels included in pixel wafer 420 may be analogous to pixels included in pixel array 105 illustrated in FIG. 1A-1E. As illustrated, stacked imaging system 400 includes ADC circuitry 444 coupled to individual pixels of pixel wafer 420 to convert analog voltages to digital values, which may subsequently be stored in frame memory 466 to facilitate faster processing and/or allow for time-of-flight operation during a longest exposure period of stacked imaging system 400.

It is appreciated that embodiments of the disclosure illustrated in FIG. 1A through FIG. 4 may be fabricated using conventional semiconductor device processing and microfabrication techniques known by one of ordinary skill in the art, which may include, but is not limited to, photolithography, ion implantation, chemical vapor deposition, physical vapor deposition, thermal evaporation, sputter deposition, reactive-ion etching, plasma etching, wafer bonding, chemical mechanical planarization, and the like. It is appreciated that the described techniques are merely demonstrative and not exhaustive and that other techniques may be utilized to fabricate one or more components of various embodiments of the disclosure.

The above description of illustrated examples of the invention, including what is described in the Abstract, is not intended to be exhaustive or to limit the invention to the precise forms disclosed. While specific examples of the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific examples disclosed in the specification. Rather, the scope of the invention is to be determined entirely by the following claims, which are to be construed in accordance with established doctrines of claim interpretation.

1. An image sensor, comprising:
a plurality of pixels arranged in rows and columns to form a pixel array, wherein each pixel included in the plurality of pixels corresponds to a repeat unit of the pixel array that includes a photodiode to accumulate charge in response to incident light, a floating diffusion configured to receive the charge, and a transfer gate configured to selectively transfer the charge from the photodiode to the floating diffusion;
a plurality of spectral filters to configure the plurality of pixels as visible pixels or non-visible pixels;
a plurality of imaging control lines coupled to the transfer gate of each of the visible pixels to configure the visible pixels as imaging pixels; and
a plurality of time-of-flight (TOF) control lines coupled to the transfer gate of each of the non-visible pixels to configure the non-visible pixels as TOF pixel cells.

2. The image sensor of claim 1, wherein each one of the TOF pixel cells includes two or more of the non-visible pixels to configure the TOF pixel cells as multi-tap TOF pixel cells, and wherein the two or more of the non-visible pixels included in each of the TOF pixel cells are separated from one another by a respective one of the visible pixels.

3. The image sensor of claim 1, wherein a first TOF pixel cell included in the TOF pixel cells includes a first non-visible pixel and a second non-visible pixel positioned in a first row included in the rows, and wherein the imaging pixels includes a first visible pixel and a second visible pixel positioned within the first row, and wherein the first visible pixel is disposed between the first non-visible pixel and the second non-visible pixel.

4. The image sensor of claim 3, wherein the plurality of TOF control lines includes a first TOF control line associated with the first row and coupled to the transfer gate of the first non-visible pixel and a second TOF control line associated with the first row and coupled to the transfer gate of the second non-visible pixel.

5. The image sensor of claim 4, wherein the plurality of imaging control lines includes a first imaging control line associated with the first row and coupled to the transfer gates of both the first visible pixel and the second visible pixel, and wherein the first imaging control line is adjacent to at least one of the first TOF control line or the second TOF control line.

6. The image sensor of claim 4, further comprising a controller configured to control operation of the first TOF pixel cell by applying a first phase modulation signal to the transfer gate of the first non-visible pixel through the first TOF control line and a second phase modulation signal to the second non-visible pixel through the second TOF control line, wherein the first phase modulation signal is out of phase with respect to the second phase modulation signal.

7. The image sensor of claim 3, wherein the rows further include a second row and a third row, wherein the second row is disposed adjacent to and between the first row and the third row, wherein the first TOF pixel cell further includes a third non-visible pixel and a fourth non-visible pixel arranged in the third row.

8. The image sensor of claim 7, wherein the third non-visible pixel and the fourth non-visible pixel are separated from one another by one of the visible pixels positioned in the third row, and wherein the first non-visible pixel and the third non-visible pixel are positioned in a same column included in the columns.

9. The image sensor of claim 1, wherein each pixel included in the plurality of pixels further includes a global shutter transistor coupled between a voltage source and the photodiode.

10. The image sensor of claim 1, wherein the plurality of imaging control lines and the plurality of TOF control lines are coupled to the pixel array on a row-by-row basis.

11. An imaging system, comprising:
a plurality of pixels arranged in rows and columns to form a pixel array, wherein each pixel included in the plurality of pixels corresponds to a repeat unit of the pixel array that includes a photodiode to accumulate charge in response to incident light, a floating diffusion configured to receive the charge, and a transfer gate configured to selectively transfer the charge from the photodiode to the floating diffusion;
a plurality of spectral filters to configure the plurality of pixels as visible pixels or non-visible pixels; and
a controller coupled to the plurality of pixels to control operation of the imaging system, the controller including logic storing instructions that when executed by the controller causes the imaging system to perform operations comprising:
driving the non-visible pixels as time-of-flight (TOF) pixel cells with multiple taps by applying a TOF signal sequence to the transfer gates included in the non-visible pixels for generating depth information, wherein a first TOF pixel cell included in the TOF pixel cells includes a first non-visible pixel and a second non-visible pixel included in the non-visible pixels, and wherein a first visible pixel included in the visible pixels is positioned between the first non-visible pixel and the second non-visible pixel.

12. The imaging system of claim 11, wherein the logic includes additional instructions included in the TOF signal sequence that when executed by the controller causes the imaging system to perform further operations, comprising:
applying a first phase modulation signal to the transfer gate of the first non-visible pixel included in the first TOF pixel cell through a first TOF control line; and
applying a second phase modulation signal to the transfer gate of the second non-visible pixel included in the first TOF pixel cell through a second TOF control line, wherein the first phase modulation signal is out of phase with respect to the second phase modulation signal.

13. The imaging system of claim 11, wherein the first visible pixel, the first non-visible pixel, and the second non-visible pixel are each positioned in a first row included in the rows, wherein the non-visible pixels include a third non-visible pixel and a fourth non-visible pixel positioned in a same row different from the first row, wherein the third non-visible pixel and the fourth non-visible pixel are included in the first TOF pixel cell, wherein a second visible pixel included in the visible pixels is positioned within the same row and further disposed between the third non-visible pixel and the fourth non-visible pixel.

14. The imaging system of claim 13, wherein the logic includes additional instructions included in the TOF signal sequence that when executed by the controller causes the imaging system to perform further operations, comprising:
sequentially applying pulses to the transfer gate of the first non-visible pixel, the second non-visible pixel, the third non-visible pixel, and the fourth non-visible pixel included in the first TOF pixel cell, wherein individual pulses included in the pulses do not overlap.

15. The imaging system of claim 11, wherein the logic includes additional instructions that when executed by the controller causes the imaging system to perform further operations comprising:
driving the visible pixels as imaging pixels by applying an imaging signal sequence to the transfer gate included in each of the visible pixels on a row-by-row basis for generating color information.

16. The imaging system of claim 15, wherein the logic includes additional instructions that when executed by the controller causes the imaging system to perform further operations comprising:
concurrently performing the applying the TOF signal sequence for the time-of-flight (TOF) pixel cells and the applying the imaging signal sequence for the imaging pixels.

17. The imaging system of claim 15, wherein the logic includes additional instructions that when executed by the controller causes the imaging system to perform further operations comprising:
concurrently reading out TOF signals representative of the depth information and image signals representative of the color information from the floating diffusion included in the plurality of pixels.

18. The imaging system of claim 15, wherein the logic includes additional instructions that when executed by the controller causes the imaging system to perform further operations comprising:
driving the visible pixels as the imaging pixels separately from driving the non-visible pixels as the TOF pixel cells through separate control lines, wherein the separate control lines include a plurality of imaging control lines coupled to the transfer gate of the visible pixels and a plurality of TOF control lines coupled to the transfer gate of the non-visible pixels.

19. The imaging system of claim 11, wherein the logic includes additional instructions that when executed by the controller causes the imaging system to perform further operations comprising:
performing the applying the TOF signal sequence for the time-of-flight (TOF) pixel cells during a vertical blanking period, wherein the vertical blanking period occurs between sequential readout time periods of the plurality of pixels.

20. An image sensor, comprising:
a plurality of pixels arranged in rows and columns to form a pixel array, wherein each pixel included in the plurality of pixels corresponds to a repeat unit that includes a photodiode to accumulate charge in response to incident light, a floating diffusion configured to receive the charge, and a transfer gate configured to selectively transfer the charge from the photodiode to the floating diffusion, wherein the plurality of pixels includes a first imaging pixel, a second imaging pixel, a first time-of-flight (TOF) pixel, and a second TOF pixel, each positioned in a first row included in the rows;
a first imaging control line associated with the first row, wherein the first transfer control line is coupled to the transfer gate of both the first imaging pixel and the second imaging pixel;
a first TOF control line associated with the first row, wherein the first TOF control line is coupled to the transfer gate of the first TOF pixel; and
a second TOF control line associated with the first row, wherein the second TOF control line is coupled to the transfer gate of the second TOF pixel, wherein the first TOF pixel and the second TOF pixel are included in a first TOF pixel cell.

21. The image sensor of claim 20, further comprising:
a row of imaging pixels included in the plurality of pixels positioned in a second row included in the rows, wherein the second row is disposed adjacently between the first row and a third row included in the rows and parallel therewith;
a third imaging pixel included in the plurality of pixels positioned in the third row;
a third TOF pixel and a fourth TOF pixel included in the plurality of pixels positioned in the third row and further included in the first TOF pixel cell, wherein the first imaging pixel is disposed between the first TOF pixel and the second TOF pixel, wherein the second imaging pixel is disposed between third TOF pixel and the fourth TOF pixel, wherein the row of imaging pixels is disposed between the first TOF pixel and the third TOF pixel, and wherein the row of imaging pixels is further disposed between the second TOF pixel and the fourth TOF pixel;
a second imaging control line associated with the second row, wherein the second imaging control line is coupled to the transfer gate for each pixel included in the row of imaging pixels;
a third TOF control line associated with the third row, wherein the third TOF control line is coupled to the transfer gate of the third TOF pixel; and
a fourth TOF control line associated with the third row, wherein the fourth TOF control line is coupled to the transfer gate of the fourth TOF pixel.
